(19) United States
(12) Patent Application Publication
(10) Pub. No.: US 2010/0035219 A1
(43) Pub. Date: Feb. 11, 2010

(54) TRAINING SYSTEM UTILIZING SIMULATED ENVIRONMENT

(75) Inventors: James E. Gerik, Dallas, TX (US); Todd W. Dalton, Arlington, TX (US)

Correspondence Address: Michael A. O'Neil. P.C., 8150 North Central Expressway, Suite 1150, DALLAS, TX, 75206, US

(73) Assignee: Epic Creative Group Inc.

(21) Appl. No.: 12/537,109

(22) Filed: Aug. 6, 2009

Related U.S. Application Data
(60) Provisional application No. 61/087,091, filed on Aug. 7, 2008.

(51) Int. Cl. G09B 19/00

(52) U.S. Cl. 434/219

(57) ABSTRACT

A simulated environment includes at least one circumstance requiring attention. One correct and multiple incorrect solutions for connecting the circumstance are provided. If one of the incorrect solutions is selected appropriate resource materials are recommended.

### CROSS-REFERENCE TO RELATED APPLICATION

Applicant claims priority based on provisional patent application Ser. No. 61/087,091 filed Aug. 7, 2008, the entire content of which is incorporated herein by reference.

### DESCRIPTION OF THE DRAWINGS

FIG. 1 is a schematic diagram of a simulator according to one embodiment of the present invention;

FIG. 2 is a depiction of a simulation according to one embodiment of the present invention;

FIG. 3 is another depiction of the simulation according to one embodiment of the present invention;

FIG. 4 is another depiction of the simulation according to one embodiment of the present invention;

FIG. 5 is another depiction of the simulation according to one embodiment of the present invention; and

FIG. 6 is another depiction of the simulation according to one embodiment of the present invention.

### DETAILED DESCRIPTION

A simulation is a representation of the behavior or characteristics of one system through the use of another system. Simulations are useful in many contexts, but are specifically useful and advantageous for training purposes. Without the aid of a simulator persons and/or property would be subject to undue risk of harm during training exercises.

During training exercises simulation is usually employed and administered if the use of physical equipment is prohibitively expensive or too dangerous for a novice. In such situations trainees will spend their time learning valuable lessons in a safe, virtual environment. Often the convenience is to permit trainee mistakes without causing physical or financial harm to person or property.

While a simulation's employment can be advantageous its creation and implementation can be extremely costly. A real life situation includes a myriad of possible circumstances, factors and outcomes. Because a simulation typically mirrors a real world situation the simulator usually simulates such circumstances, factors, and outcomes so as to provide the trainee with an equivalent real life experience. Therefore, the simulator must be fed data comprising an abundance of information to accurately portray the real life situation to the trainee during simulation. Much work is expended to create such data thereby dramatically increasing the cost associated with the creation and employment of simulators.

Utilizing the internet or other means to transmit the voluminous amounts of data needed to support a typical simulator's real life simulation is usually not practical due to the lack of adequate internet bandwidth. Acquiring enough bandwidth is usually prohibitively expensive and therefore not feasible. As such simulations are usually performed where the simulator and the data are proximate each other.

Embodiments of the present invention comprise a method for providing an interactive graphical simulation environment over the internet. Because the simulator of this present invention introduces only salient and obvious circumstances, factors, and outcomes during the simulation, the simulator does not require an abundance of internet bandwidth and therefore can be implemented with ordinary internet bandwidth use.

An embodiment of the invention provides a method in which a user is provided a simulated environment, a simulated circumstance in the simulated environment, directions and/or access to relevant information when the user selects an incorrect solution, at least one correct solution and explanations as to why the correct solution is correct. The user interacts with the simulator during each step, providing answers to questions and receiving feedback from the simulator.

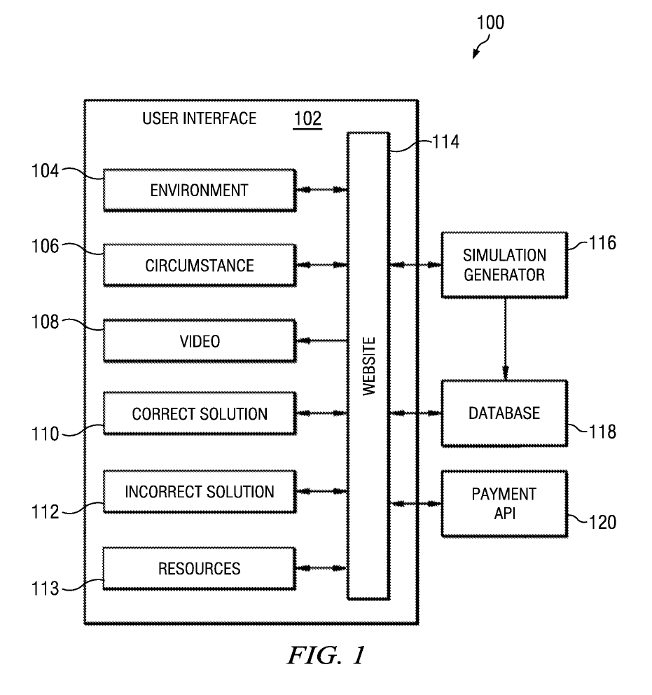

As shown in FIG. 1, an embodiment of the present invention 100 comprises a user interface 102, simulation generator 116, database 118 and payment application programming interface (hereinafter “payment API”) 120, wherein the user interface 102 comprises a website 114, environment 104, circumstance 106, correct solution 110, and incorrect solution 112. The user interface 102 may also comprise video 108. The embodiment 100 may be delivered to the user via a host based system such as the internet or other online system or delivered to the user via hard media such as CD-ROM, DVD-ROM, flash media or the like.

The user interface 102 further comprises a virtual environment modeled in three dimensions in a polygonal mesh with photo realistic lighting and shading. The user interacts with the virtual environment via a vector-based, animated graphical user interface. Additionally, the user interface 102 may incorporate video clips, thereby enhancing the user's learning experience.

Specifically, the user interface comprises a system such as a particular machine, device, computer program or other complex tool. Preferably, the user interface 102 comprises a website 114 and provides means of input wherein the user is allowed to manipulate the system and also provides means of output wherein the system produces the effects of the user's manipulation.

In addition, the user interface 102 comprises means for inputting, selecting, and displaying information and data to and from an embodiment of the present invention 100. Such means include without limitation a graphical, textual, and/or auditory apparatus and a control sequence such as but not limited to keystrokes with a computer keyboard, movements of a computer mouse, and/or selections with a touch screen.

The user interface 102 links to the simulation generator 116, database 118 and payment API 120. The simulation generator 116 creates the simulation environment 104 and circumstance 106 within the simulated environment 104. For example, the simulation generator 116 can create an environment comprising a simulated room within a simulated hospital for treating simulated patients and the circumstance comprises a simulated toddler having breathing problems.

The simulation generator 116 can incorporate video 108 into the website 114 such that, for example, the toddler having breathing problems is shown gasping for air via a video clip 108. If a video clip 108 is not utilized the circumstance is depicted using three dimensional modeling, shaded and lit to simulate a real world circumstance in a real world environment.

After the circumstance 106 is presented the user is prompted to supply information to the website 114 to solve the problem presented by the circumstance 106. The user is given several choices from which to choose. If the user chooses an incorrect solution 112, the simulation generator 116 alerts the user via the website 114 that the chosen solution is incorrect and directs the user to recognized resource materials 113 for further study, i.e., audio, video, print, etc. If, however, the user chooses the correct solution, the simulator generator 116 alerts the user via the website 114 that the chosen solution is correct and displays an explanation as to why the chosen solution is correct.

The database 118 links to the simulator generator 116 and the website 114. The database 118 comprises data relating to the information needed by the simulation generator 116 to create the environment 104, circumstance 106 within the environment 104, video 108, correct solution 110, and incorrect solutions 112.

Additionally, the payment API 120 links to the simulation generator 116 and website 114. The payment API 120 connects to a payment processing agency such as a bank or credit card company, allowing the procurement of payment. The user submits and receives confirmation of payment via the website 114.

To commence simulation training the user selects the specific environment 104 from the website 114. Once selected the user selects the specific circumstance 106 within the environment 104. Video clips 108 may be integrated into the simulation. Then, the user is prompted to solve the presented problem by selecting the correct solution. If an incorrect solution 112 is selected the user is directed to recognized source materials for research by the user. However if the correct solution 110 is selected the user is provided a detailed explanation as to why the chosen solution is correct.

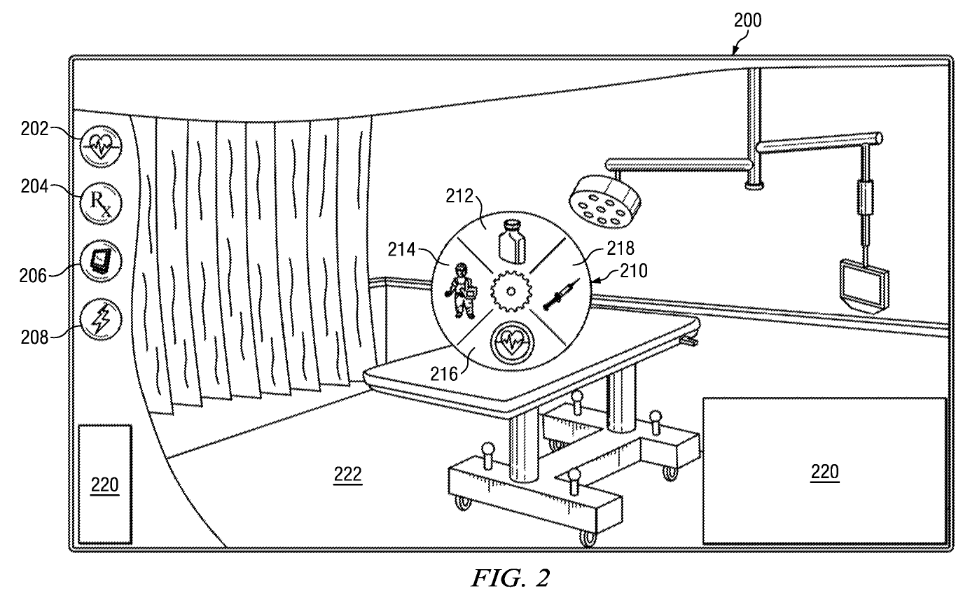

FIGS. 2-6 illustrate an example of an embodiment of the present invention. FIG. 2 depicts a simulation wherein the user is provided several different environments from which to choose. Specifically, the user may choose to generate simulation environments relating to medicine exhibited graphically on the website by the following icon buttons: electrocardiogram 202, prescription 204, patient charting 206, and defibrillator 208. FIG. 2 depicts the selection of the prescription icon button 204. Upon the selection of the prescription icon button 204 a dialogue box 210 is displayed wherein the dialogue box 210 comprises several different circumstances within the prescription environment: prescription drugs icon 212, head tilt/chin lift icon 214, heart monitoring icon 216, or medications icon 218. In this example the head tilt/chin lift icon 214 is chosen.

Additionally, FIG. 2 comprises text regions 220 wherein various amounts of text are displayed. Also, the background 222 of the environment is displayed in three dimensions utilizing a polygonal mesh, shaded and lit to simulate a real world environment.

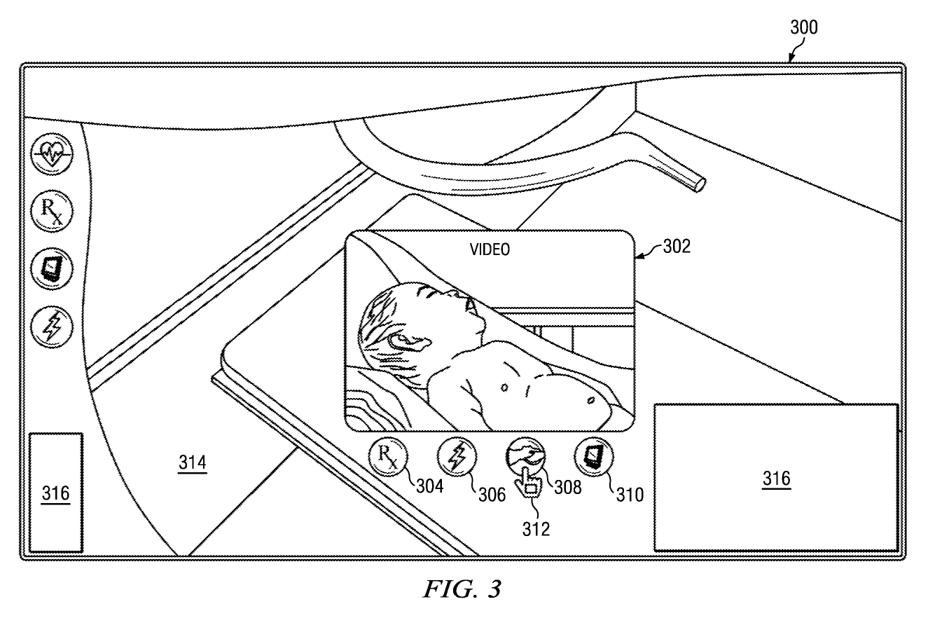

FIG. 3 depicts the simulation after the head tilt/chin lift icon 214 of FIG. 2 is selected. Upon selection, the background 222, 314 of the environment changes through a sequence of still images, thereby simulating camera movement.

As shown in FIG. 3 a video clip 302 is incorporated into the simulation 300. The video clip 302 comprises an infant struggling to breathe. Also, various text in text boxes 316 may provide instructions or present questions regarding the particular simulation depicted.

To solve the problem presented in the video clip 302 the simulation provides active regions comprising icons for the user's selection. Each icon represents a correct or incorrect solution to the given problem. As illustrated in FIG. 3, the user may select a prescription solution icon 304, defibrillator solution icon 306, head-support solution icon 308 or a patient charting solution icon 310. With a pointing device 312, the user of FIG. 3 selects the head-support solution icon 308.

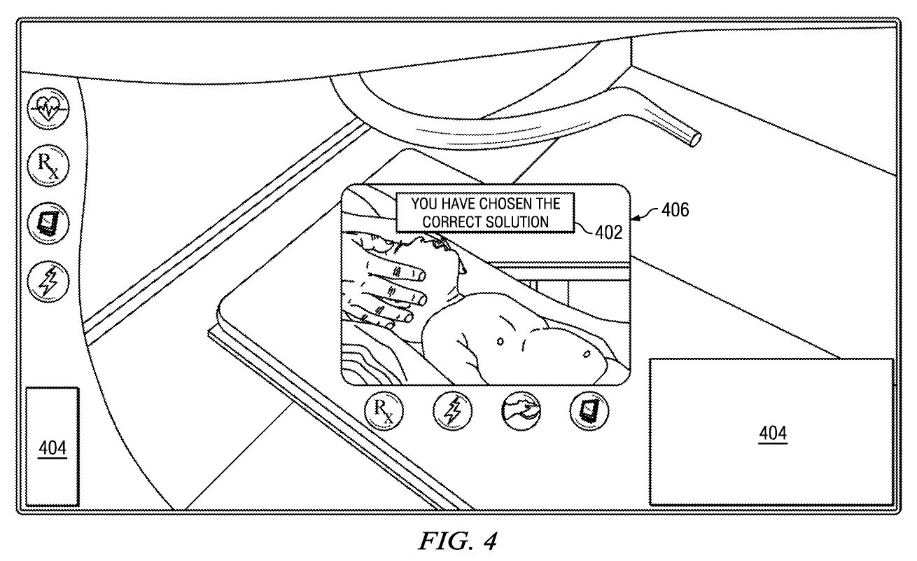

FIG. 4 illustrates the simulation upon the user of FIG. 3 selecting the head-support solution icon 308. Upon selection the user of FIG. 4 is notified via a text box 402 and associated text that the correct solution was chosen and is provided with an explanation via text boxes 404 and associated text as to why the solution is correct. Additionally after the correct solution is selected a video clip may be incorporated into the simulation showing the implementation of the correct solution. In FIG. 4 a video clip 406 is incorporated into the simulation showing an individual providing head-support to the infant, thereby increasing the infant's wind-passage and providing aid to the infant struggling to breathe.

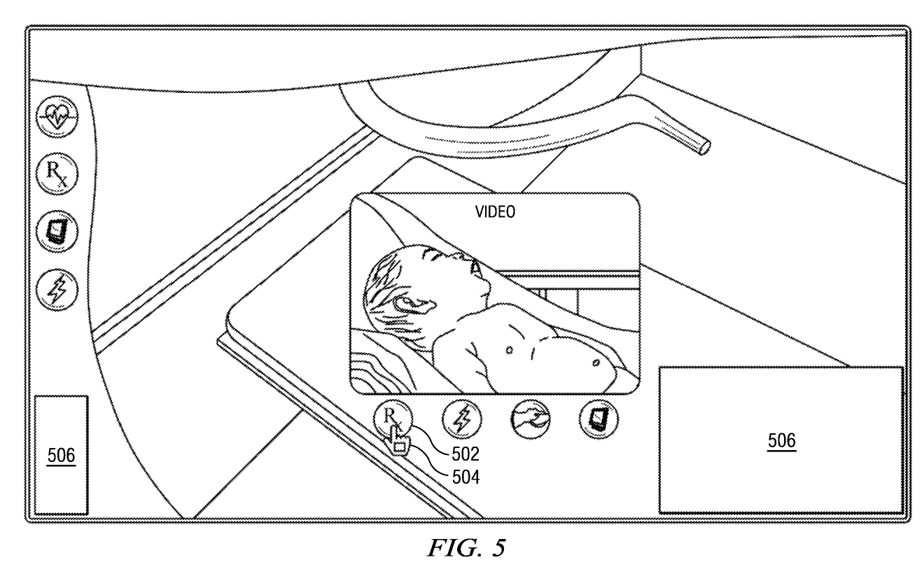

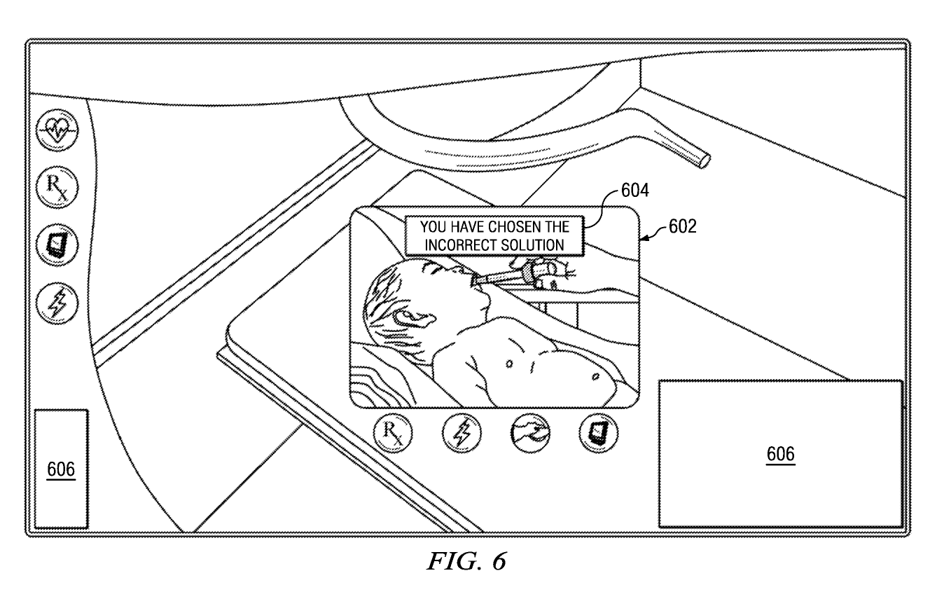

If, however, the user of FIG. 3 utilizes the pointing device 506 to choose the prescription solution icon 502 as shown in FIG. 5, the user would have chosen an incorrect solution. Upon selection of an incorrect solution as shown in FIG. 6 the user is notified via a text box 604 and associated text that an incorrect solution was chosen and is directed to appropriate resource materials 113, including but not limited to audio, video, print, etc.

If an incorrect solution is selected a video clip may be incorporated into the simulation showing the implementation of the incorrect solution. In FIG. 6 a video clip 602 is incorporated into the simulation showing an individual orally providing prescription drugs to the infant and not aiding the infant's breathing.

The embodiments of the present invention apply to simulations, regardless of type, function or content, user interfaces, regardless of type, function or content, environments, regardless of type, function or content, circumstances, regardless of type, function or content, videos, regardless of type, function or content, simulation generator, regardless of how the simulation is generated, and database, regardless of type, function or data content.

Although the embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

We claim:

1. A training system comprising:
a simulated environment;
the simulated environment including at least one component requiring immediate correction;
a plurality of individually selectable procedures for effecting the required correction of the component;
one of the individually selectable procedures comprising the correct procedure;
the remaining selectable procedures comprising incorrect procedures;
means responsive to actuation of the correct selectable procedure for generating a first predetermined output;
providing a plurality of resource materials relating to the selectable incorrect procedures; and
means responsive to actuation of one of the incorrect procedures for selecting resource materials relating to the selected incorrect procedure from the plurality thereof.
